(19) United States
(12) Patent Application Publication
(10) Pub. No.: US 2024/0346709 A1
(43) Pub. Date: Oct. 17, 2024

(54) USER-GUIDED VISUAL CONTENT GENERATION

(71) Applicant: Useful Bird, Inc., Beaverton, OR (US)

(72) Inventors: Indigo Jay Dennis ORTON, Melbourne (AU); Pierre Victor Michel THODOROFF, Cambridge (GB)

(21) Appl. No.: 18/133,969

(22) Filed: Apr. 12, 2023

(51) Int. Cl. G06T 11/00; G06F 3/0484; G06F 40/40

(52) U.S. Cl. CPC G06T 11/00; G06F 3/0484; G06F 40/40; G06T 2200/24

(57) ABSTRACT

A method of generating a visual content item comprises receiving input from a user comprising text. The method computes values of input parameters from the received input and from observed interactions with other visual content items by the user or other users. The visual content item is generated by inputting the computed values of the input parameters to a generative machine learning apparatus.

### BACKGROUND

Visual content items such as images, videos, three-dimensional models and other visual content items are used for many purposes including but not limited to: illustrating how a piece of equipment is to be used, illustrating a book, video games, education, and other purposes. However, it is often time consuming and costly to generate visual content items manually such as by capturing digital photographs and videos using cameras. Synthetic generation of images using graphics engines is also time consuming and costly since an expert user typically configures the graphics engine and specifies details to be included in the generated images. Manual generation of three-dimensional models such as mesh models of objects to be rendered from to create visual content is time consuming.

The examples described herein are not limited to examples which solve problems mentioned in this background section.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A user-guided visual content generation service is able to generate visual content items automatically. By observing textual and behavioural input of a user it is possible to generate visual content items that are highly relevant to a user.

A method of generating a visual content item comprises receiving input from a user comprising text. The method computes values of input parameters from the received input and from observed interactions with other visual content items by the user or other users. The visual content item is generated by inputting the computed values of the input parameters to a generative machine learning apparatus.

Other examples will become apparent from the following detailed description, which, when taken in conjunction with the drawings, illustrate by way of example the principles of the disclosed technology.

### BRIEF DESCRIPTION OF THE DRAWINGS

FIG. 1 is a schematic diagram of a user-guided visual content generation service;

FIG. 2 shows more detail of the user-guided visual content generation service of FIG. 1;

FIG. 3 is a schematic diagram of a method performed by the user-guided visual content generation service of FIG. 1;

FIG. 4 is a schematic diagram of a method performed by an input parameter recommender;

FIG. 5 is a flow diagram of a method performed by an input parameter recommender;

FIG. 6 is a schematic diagram of a method performed by an output visual content item recommender;

FIG. 7 is a flow diagram of a method performed by an information seeking engine;

FIG. 8 is a flow diagram of a method performed by a user feed recommender;

FIG. 9 is a schematic diagram of a computer used to implement a user-guided visual content generation service.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is made for the purpose of illustrating the general principles of the present technology and is not meant to limit the inventive concepts claimed herein. As will be apparent to anyone of ordinary skill in the art, one or more or all of the particular features described herein in the context of one embodiment are also present in some other embodiment(s) and/or can be used in combination with other described features in various possible combinations and permutations in some other embodiment(s).

As mentioned above it is often time consuming and costly to generate visual content manually. Generative artificial intelligence models which generate images may be used to generate images automatically. However, often these do not create images that a user was intending or desired; that is the created images do not correspond to a user's imagination. The same is found for generative models which generate videos, three-dimensional models of objects, or other visual content items. The present technology provides a user-guided visual content generation service that works with a user as a creative tool to generate a best visual content item for a user's aims.

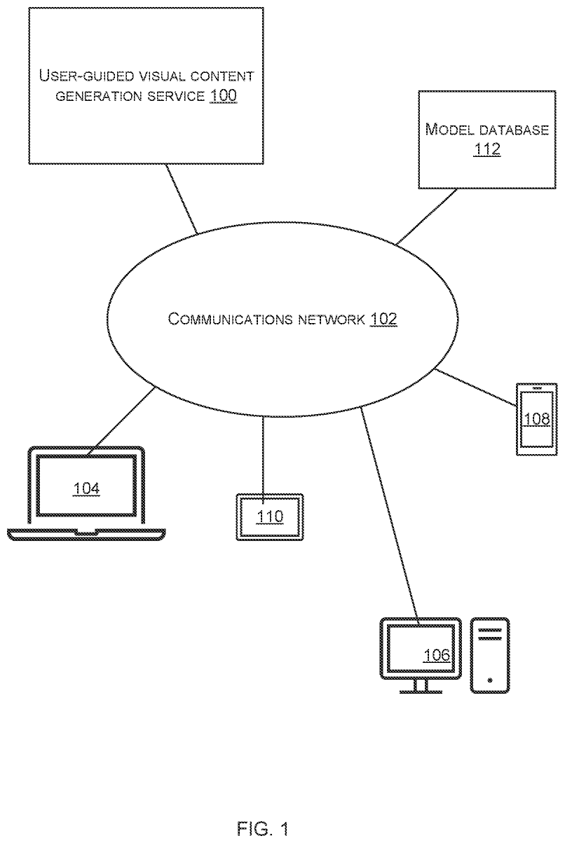

FIG. 1 is a schematic diagram of a user-guided visual content generation service 100 deployed as a web service accessible to client devices such as laptop computer 104, tablet computer 110, desktop computer 106, cell phone 108 via communications network 102. Communications network 102 is the internet, an intranet or any other communications network. The client devices are examples and are not intended to be limiting as any computing device which is able to access the user-guided visual content generation service 100 via communications network 102 is a client device.

The user-guided visual content generation service 100 is computer implemented and comprises functionality to generate visual content items. The generated visual content items are images, videos, three dimensional (3D) models such as mesh models of objects, 3D point clouds, other 3D models, or other visual content items. Where images are generated these may be color images in any format such as jpeg, tiff, png, gif.

The generated visual content items are sent to one or more of the client devices for display as part of a feed on the client device in some cases. In other cases the generated visual content items are sent to another computing entity via the communications network for use in a downstream process such as content creation, video games, creation of instruction manuals, creation of books or other content.

The user-guided visual content generation service 100 generates visual content items in response to input from a user, such as a user of one of the client devices or a user of another process such as a video game. The user input typically comprises text, comprising a prompt, such as a text prompt which is input by a user in any suitable way such as by speaking, by typing, by using a graphical user interface.

Since it is often difficult for a user to express using text what visual content item he or she wants to create, the present technology comprises a user-guided visual content generation service. By using behavioural interaction data and/or textual interaction data it is possible to improve the relevance of visual content items created by the user-guided visual content generation service.

A method of generating a visual content item comprises receiving input from a user comprising text. In this way the technical problem of how to reduce burden of user input to a visual content generator is achieved, since the user is able to input only text such as by speaking, typing or in other ways. The text may comprise information about content to be depicted in the generated visual content item. In some cases the text comprises one or more of: a visual content item description, an image description, a target audience, a product description, a video description, a 3D model description.

In some examples the method is repeated, and an exploration coefficient is decayed as the method repeats. The exploration coefficient influencing how the values of the input parameters are computed so that when the exploration coefficient is high variation between visual content items generated by the method is high and when the exploration coefficient is low variation between visual content items generated by the method is low.

Exploration is aimed at discovering which visual content item a user might like by exposing very different variations. In contrast exploitation attempts to find the perfect visual content item by doing minor modifications to already liked visual content items. The balance between both exploration and exploitation is modulated using an exploration coefficient that is slowly decayed through the interaction with the user (i.e. the more the user interacts, the more the machine focuses on narrowing in one what the user wants and less on exploring the possible options).

The method computes values of input parameters from the received input and from observed interactions with other visual content items by the user or other users. By computing values of input parameters from observed interactions with other visual content items by the user it is possible to take into account what the user has previously found relevant or not relevant in visual content items. By taking into account observed interactions with other visual content items by other users it is possible to have more information since there is generally more information available by looking across multiple users than looking for only one user. In this way the values of the parameters produce more relevant visual content items when used to generate visual content items from a generative machine learning apparatus, such as an image generator, a video generator or a 3D model generator. The visual content item is generated by inputting the computed values of the input parameters to a generative machine learning apparatus. Thus the generated visual content item depicts relevant content in a way desired by the user (such as with appropriate viewpoint, lighting, color range and other attributes).

When observed interactions with other visual content items by other users are used, it is often possible to identify other users who have similar characteristics to a current user and to use their observed interactions to compute the parameter values.

The observed interactions are observed from browser data or in other ways and with any appropriate user consents obtained.

The user-guided visual content generation service 100 uses a generative machine learning apparatus to generate visual content items. A non-exhaustive list of examples of generative machine learning apparatus is: diffusion model, variational autoencoder, other visual content generation model. A model database 112 is available and accessible via communications network 102. The model database 112 comprises a plurality of generative machine learning models for generating visual content items such as diffusion models, variational autoencoders, or other models. The user-guided visual content generation service 100 may select one of the models to use from the database according to a value of one of the input parameters.

A diffusion model is a neural network which has been trained to denoise images blurred with Gaussian noise. Any diffusion model may be used such as DALL-E (trade mark), Stable Diffusion (trade mark). A non-exhaustive list of examples of models which may be used to generate video from text is: Make-A-Video by Meta Platforms (trade mark), Gen1 by RunwayML (trade mark). A non-exhaustive list of examples of models which may be used to generate 3D models from text is: DreamFusion (trade mark), Imagine 3D from Luma AI (trade mark), OpenAI's “Point-E” (trade mark).

At the end of a textual user input the service may add keywords to prompt the service to change the lighting or viewpoint of a generated image, video or other visual content item. If a user likes an image, video or other visual content item with bright lighting, an observation of that like event is used to enable the service to select bright lighting as a parameter value in future. If a user is observed to prefer an artistic visual content item over a photo-realistic one the service is able to select a model which generates artistic visual content from the model database for that user in future.

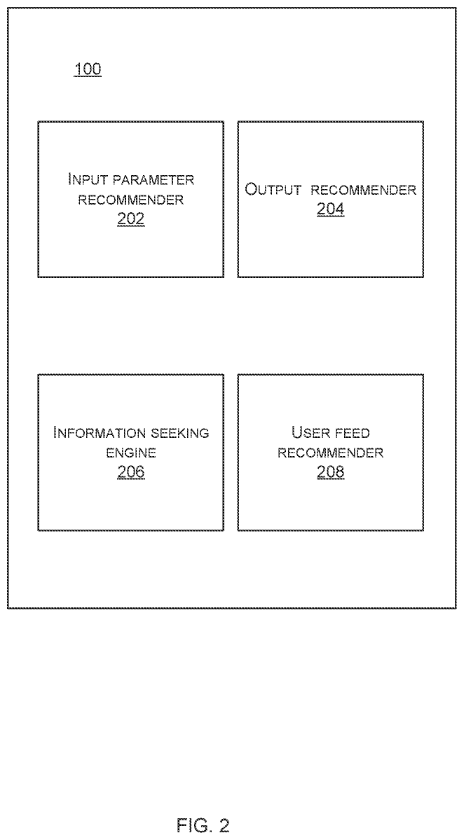

FIG. 2 shows more detail of the user-guided visual content generation service 100 of FIG. 1. There are four components, an input parameter recommender 202, an output visual content item recommender 204, a information seeking engine 206 and a user feed recommender 208.

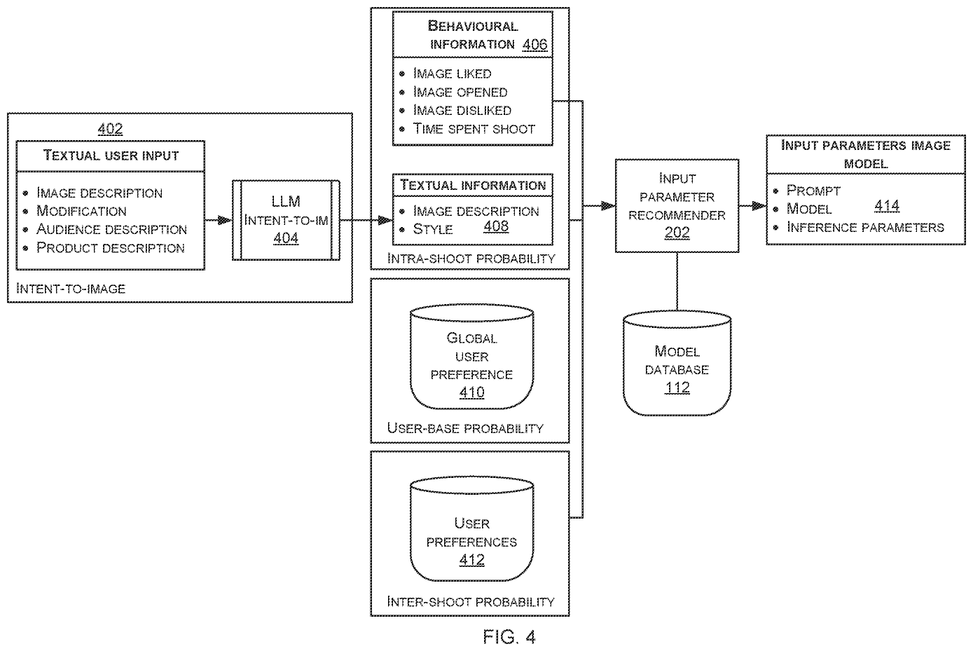

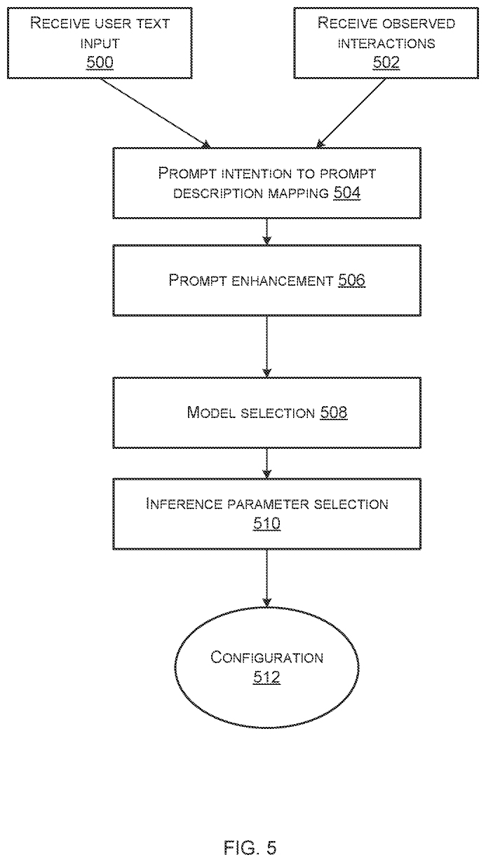

The input parameter recommender 202 is described in detail with reference to FIGS. 4 and 5. It takes as input a text input (referred to as a prompt) from a user (referred to as a current user) at any of the client devices. It also takes as input any observed interactions with other visual content items by the current user or other users. The observed interactions are observed by observing activity of a web browser at each of the client devices, where the web browser provides the user-guided visual content generation service. The observed interactions are stored in a user database which is accessible to the input parameter recommender. In an example, the input parameter recommender queries the user database for any data about observed interactions with other visual content items by the user. The input parameter recommender may additionally or alternatively query the user database to retrieve observed interactions by other users who are similar to the current user (such as by being in a same demographic group or by being part of the same organization).

The input parameter recommender 202 uses the inputs it receives in order to compute values of input parameters. The values of the input parameters are sent by the input parameter recommender 202 to a generative machine learning apparatus such as one of the diffusion models or other generative models from the model database. The diffusion model thus generates one or more visual content items.

The output visual content item recommender 204 receives the visual content items generated by the generative model. It sorts the visual content items using rules or heuristics or criteria to produce an ordered list of visual content items. Examples of criteria include but are not limited to: similarity with visual content items liked by the user previously, diversity with respect to other visual content items to be included in a feed to the user. In an example, it sorts the visual content items according to similarity with other visual content items that the user has selected to indicate the user likes the visual content items. In another example, it sorts the visual content items to promote diversity between visual content items to be displayed to the current user in a feed. The ordered list of visual content items produced by the output visual content item recommender 204 is passed to the user feed recommender 208, along with items from the information seeking engine 206.

The information seeking engine 206 generates items that, if the user interacts with them, would provide useful information to the service. For example, this could be a textual question for the user to answer (e.g. “would you like more people in your image?”), a selection question (e.g. “which of these two images has better lighting?”), or a range of other possible interactions. These items are passed to the user feed recommender 208 along with the ordered list from the output visual content item recommender 204.

The user feed recommender 208 takes in an ordered list of visual content items from the output recommender 204 and a set of information seeking items from the information seeking engine 206 and interleaves the visual content items and information seeking items to produce an ordered list of visual content items and information seeking items to show in a user feed (i.e. a primary user interface at the client device of the current user). There are a complex set of actions occurring “behind the scenes” to generate visual content items for the current user and to try and determine what the current user is looking for, but the service presents a simple interface (a feed) for the user to interact with. This allows the user to focus on their creative process and not on how to work with a complex system.

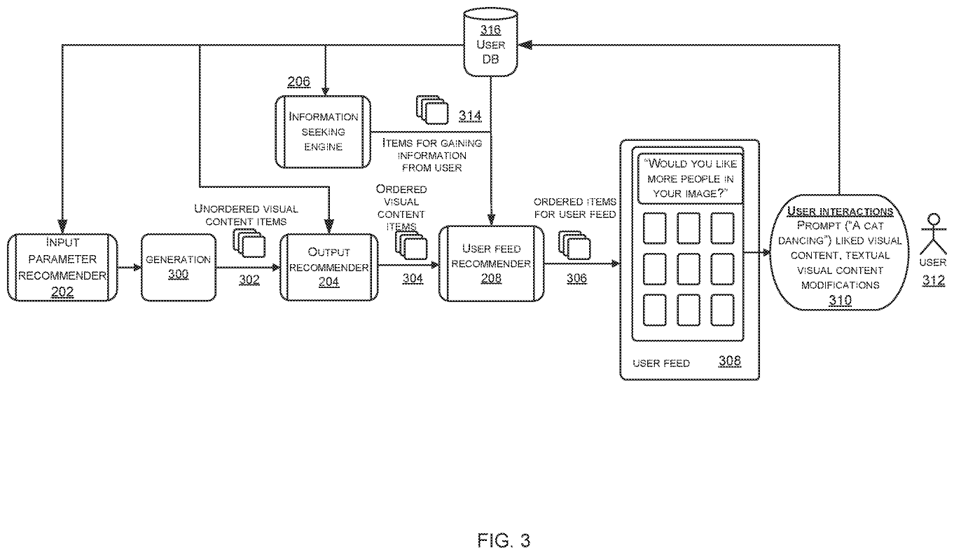

FIG. 3 is a schematic diagram of a method performed by the user-guided visual content generation service of FIG. 1. A user 312 accesses a graphical user interface of the service at a client device such as by using a web browser. The interaction works as follows: first, the user inputs 312 some text to start the service generating visual content items. This text (referred to as a prompt) is any one or more of: an image description, a video description, a 3D model description, a target audience, a product description, a visual content item description, other text, for which the user wants to generate visual content items. An example of a visual content item description is “a cat dancing”. An example of a target audience is “teenagers interested in football”. An example of a product description is “sparking, soft drink”.

The user 312 then interacts iteratively with the service to obtain the desired visual content item. There are two interaction types: behavioural and textual. Behavioural interactions include actions such as opening, liking, or disliking a visual content item; behaviours that can be recorded in the browser. More generally, a behavioural interaction comprises a user interface event associated with a visual content item displayed at a user interface Textual interactions are any text input made by the user in association with a visual content item or modifications to a prompt use to generate a visual content item displayed at a user interface. Textual interactions are often open-ended and can include requests such as “add a person to this photo” or “make it darker,” as well as modifications to the original user input prompt.

The behavioural and textual interactions are together referred to as observed interactions and are observed by observing events in the web browser of the client devices. The observed interactions (comprising observed events) are stored in a user database 316. In some cases the observed interactions are stored in the form of frequency counts or other statistics so as to be compact thus enabling the process to be scalable.

The input parameter recommender 202 uses input from the user database 316 about the observed interactions and it also uses the prompt from the user (text, an image description, a video description, a 3D model description, a visual content item description, a target audience or a product description). The input parameter recommender 202 computes values of input parameters from the received input (prompt) and the observed interactions. In an example, the input parameters comprise: models (such as an identifier of a model), prompts and inference parameters. A non-exhaustive list of examples of inference parameter is: initial latent noise, guidance scale, number of inference steps, resolution of generated image or video, noise schedule, negative prompt.

The input parameter recommender 202 inputs the values of the parameters it computes to a diffusion model (referred to as generation 300 in FIG. 3) or other generative model for generating visual content items. The diffusion model (or other generative model) generates one or more unordered visual content items 302 which are input to the output recommender 204. The output recommender 204 has access to the observed interactions (see FIG. 3). The output recommender produces an ordered list of visual content items 304 as explained above. The ordered list of visual content items 304 are input to a user feed recommender 208.

The user feed recommender 208 has access to observed interactions from the user database 316. It also receives input comprising items 314 for gaining information from the user 312. The items 314 for gaining information from the user 314 are computed by the information seeking engine 206.

The user feed recommender 208 interleaves the information seeking items 314 and the ordered visual content items 304 to produce ordered items 306 for the user feed. The ordered items are fed into a user feed and transmitted to the client device for display as a feed at the client device. FIG. 3 shows an example user feed 308 at a client device comprising nine thumbnail images in a grid display and an information gaining item which is a question “would you like more people in your image”. The user feed 308 is a non-limiting example.

Using behavioural interactions brings several benefits. Fundamentally, systems that only accept text input are limited in their ability to generate visual content items that match a user's desired outcomes as it is very challenging to describe a visual content item with just text. Behavioural inputs, such as liking a visual content item or disliking another visual content item, provide a more faithful mechanism for users to provide more subtle indications of what it is they are looking for. For example, articulating the difference between two subtly different forms of lighting is very challenging, but indicating “these two images are good and these two images are bad” is very easy. The service learns from these sorts of indications (by observing interactions) to identify what it is the user is looking for.

FIG. 4 is a schematic diagram of an example method performed by an input parameter recommender 202. The input parameter recommender takes in user text input and observed interactions and selects values of input parameters, for the visual content generator, that should generate visual content items that are closer to what the user is looking for.

In practice, there are many visual content generation models, each with many input parameters. By analyzing user observed interactions, it is possible to learn which parameters correspond to the user's preferences and use those parameters to generate new visual content items.

The example of FIG. 4 shows a particular selection of input parameters to aid understanding of the technology. However, FIG. 4 is not intended to be limiting as other combinations of input parameters are used in other examples. The term “shoot” refers to a plurality of images which are semantically related and equate to a photoshoot. The example of FIG. 4 is given with respect to images and shoots although it can also be used for other types of visual content items.

In the example of FIG. 4 the observed interactions available to the input parameter recommender 202 comprise an inter-shoot probability 412, a user-base probability 410 and an intra-shoot probability.

An inter-shoot probability 412 is a numerical value, one for each of a plurality of input parameter values, indicating a number of times the user chose an image generated with that input parameter value for all shoots generated by the user. An inter-shoot probability 412 can also be a probability between shoots within a project where a project is a plurality of shoots where the shoots are created by the same user or different users. Shoots in a project are semantically related. In an example, a project is about an energy drink and is titled “Energy Boost 2023” and comprises three shoots titled “Daylight basketball”, “Beach by sunset”, “Skiing”. The inter-shoot probability informs the image generation service “what sort of images are desired for this energy drink project?” which means that the image generation service doesn't start with a blank slate on every new shoot.

A user-base probability 410 is a numerical value, one for each of a plurality of input parameter values, indicating a number of times an image generated with that input parameter value was selected by any user of the image generation service. Thus user-base probability represents the preference of all users on the platform, where the platform is the image generation service.

An intra-shoot probability is a numerical value, one for each of a plurality of input parameter values, indicating a number of times an image generated with that input parameter value was selected by a user within a shoot. Thus, an intra-shoot probability represents the preference the user has within a shoot for specific input parameter values. The intra-shoot probability comprises behavioural information 406 which is observed interactions with images in a shoot made by the user. The intra-shoot probability also comprises textual information 408 comprising an image description and a style of images in the shoot the user interacted with. In some examples the textual information 408 is textual user input 402 which has been enhanced using a large language model 404. For example, a large language model can be used to generate semantic variation of a user input such as “a house” being transformed into “a villa”. Another example is enhancing the prompt “a house” into “a pretty house”.

The term “large language model” is used to refer to a generative machine learning model which receives input comprising a text prompt and generates text in response. Any large language model may be used such as general pretrained transformer GPT 2 to 4 from OpenAI (trade mark), Bidirectional Encoder Representations from Transformers BERT (trade mark), pathways language model PALM (trade mark).

The input parameter recommender 202 has access to the model database 112 and selects one or more identifiers of models from the database to be a value of one of the input parameters. The input parameter recommender 202 produces a prompt, a model identifier and a values of inference parameters. A set of values of the parameters computed by the input parameter recommender are referred to as a configuration.

FIG. 5 is a flow diagram of a method performed by an input parameter recommender such as that of FIG. 2, 3 or 4. The input parameter recommender 202 receives 500 user text input comprising any of: a visual content item description, an image description, a target audience, a product description, or any other text. It also receives observed interactions 502 which may be textual or behavioural or both.

The input parameter recommender 202 carries out prompt intention to prompt description mapping 504 using a large language model. This is extremely useful since in many cases the user does not know exactly what they want but only know the audience or product they require visual content items for. For example, a large language model is used to convert the target audience or the product description into a prompt that describes a visual content item. The conversion is done by entering the intention prompt (e.g. target audience or product description) into a large language model and receiving as output text which is a description of a visual content item.

Using a large language model, convert a prompt intention, as opposed to description, into a prompt that describes a visual content item. For example, a user can enter a description of an audience and message and the service uses a large language model to convert that input into a prompt (e.g. converting “men aged 25-45, interested in sports, living in California, interested in buying new sunglasses” into “A photo of a man sitting on a boat on a lake on a sunny day, wearing sunglasses, smiling”).

For audience descriptions, ask the large language model the following: “Create a visual content item description for the following audience: {audience_input}”, where {audience_input} corresponds to the user's description of the targeted audience. Then use the output of the language model as input to the visual content generation model. Also use language models to transform product descriptions into visual content item descriptions.

This intent-to-visual content item mapping is also used when the service solicits textual feedback from users. For example, a user might say, “show me more artsy pictures”. The service utilizes a large language model to incorporate this feedback into a prompt. Specifically, ask the language model to “rephrase {prompt} by incorporating the following feedback: {feedback}”. In this case, {prompt} refers to the prompts used to generate visual content items, and {feedback} refers to the user's feedback.

The input parameter recommender 202 carries out prompt enhancement 506. A prompt is a text input that dictates what the visual content item generation model should create. Given a user input prompt (such as output from operation 504 or received direct from a user), the input parameter recommender construct prompts in an iterative manner by adding suffix and prefix. For example, define several categories {lighting}, {body position}. {camera} and create a sentence as follows “A photo of {user_input} in {lighting}, {body_position}, {camera}”.

In various examples a large language model is used to enhance a text prompt input by the user. In an example this is done by sentence variation. A large language model is used in some cases to compute multiple variations of a user's input to vary any of: hair color of a person depicted in the generated visual content item, lighting depicted in the generated visual content item, viewpoint of the generated visual content item, style of the generated visual content item.

In some cases the large language model has been fine-tuned using prompts liked by other users. Since there may be many hundreds of thousands of other users the quantity of prompts liked by other users is high and so the quantity of training data is in the hundreds of thousands. The refined model is then used as a “prompt enhancer” for the visual content generation models. An initial prompt is input to the fine-tuned language model and the fine-tuned language model generates one or more enhanced prompts. Since each visual content generation model responds differently to prompts, this fine-tuning process can be independently applied to each mode.

The input parameter recommender 202 selects 508 a model from the model database. In an example, selecting a model from a database of models is done according to at least one of four values:
a number of visual content items produced by each model which have been liked;
a priori probability for each model based on user preference;
a prior probability over the models across users;
a most likely model to be chosen according to a prompt.

Using these four values is found to be particularly effective in practice.

In an example, a model is selected from the database of models by, for each model, aggregating the four values and selecting one of the models by comparing the aggregated values with a threshold. Aggregating is efficient to compute and selecting by comparing aggregated values with a threshold is found effective.

In an example there are N models. For each model aggregate the four values mentioned above by taking a weighted mean. Then select one of the models which has the highest weighted mean.

In an example, the four values above are computed and aggregated for each prompt in order to select one of the prompts. In an example the four values above are computed and aggregated for each inference parameter in order to select one value for that inference parameter.

In an example, the models are diffusion-based models for image generation. However, the service is agnostic to the specific underlying model used for visual content generation. Indeed, a substantial value of the service is that it is not model-specific and can instead “get the best out of any model”. In practice, train many models for visual content generation. For example, models that generate photorealistic visual content, artistic visual content, illustrations, and so forth. Furthermore, train models to specifically generate visual content in user-specified styles (e.g. train a model to represent the style of a particular fashion “season”).

The input parameter recommender 202 selects 510 values of the inference parameters. A non-exhaustive list of example inference parameters is given below. An inference parameter is an input to or a hyperparameter of the generative machine learning model.

Initial latent noise: when running diffusion models, the model takes as input some noise sampled from a gaussian distribution. Store and re-use this information to create variations of visual content items that a user liked by sampling closely from the liked initial latent noise.

Guidance scale: this parameter dictates how closely the model is to follow the prompt. Intuitively a large guidance scale value leads to visual content items that follow the prompt closely but tend to be a bit more un-realistic (too much contrast for example).

Number of inference steps: the quality of a visual content item is often linked to the number of inference steps used. However, this also slows down the speed of inference.

Resolution: the resolution used for an image (for example 512×512 pixels) or video or 3D mesh model.

Noise schedulers. This parameter specifies details of a noise scheduler used as part of a diffusion model.

Negative prompt: things you do not want to see in a visual content item.

However, it is important to understand that there is an ever-growing number of inference parameters and the service is built to be agnostic to the specific inference parameters.

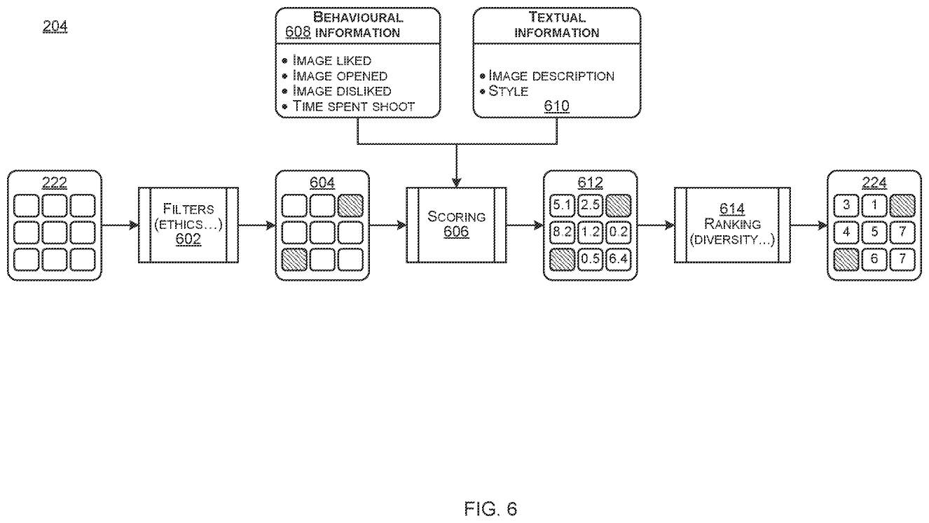

FIG. 6 is a schematic diagram of a method performed by an output recommender 204. FIG. 6 is described for the case where the visual content items are images. However, the method of FIG. 6 is also used where the visual content items are of other types such as videos, 3D models or other visual content items. Given a list 222 of generated images, the output image recommender 204 orders the list 222 based on which images will best match the user's preferences (based on their behaviour). There are three steps in this process: filtering, scoring, and ranking.

### Filtering (Ethics)

To avoid showing accidentally-generated offensive content, incorporate a filtering stage using filters 602 to remove all content marked as offensive by a machine learning classifier. For example, this might include violent or pornographic content. FIG. 6 shows filtered images 604.

### Scoring 606

Rank newly generated images based on user behavior to surface the best ones. To do this, identify and show images that are most similar to those the user has already liked. Access behavioural information 608 and textual information 610. Measure similarity by analyzing the input parameter space (e.g. images using a similar model) and by using an embedding to compare the generated images themselves. This FIG. 6 shows the filtered images with scores at 612.

### Ranking 614

Scoring is in charge of individually quantifying how relevant is an image. Ranking in contrast looks at all the pictures and decides in which order should the images be displayed. For example, images from a specific model might be scored highly but to improve the diversity of the images shown, the ranking needs to be modified to alternate between less highly ranked images. FIG. 6 shows ranked images 224.

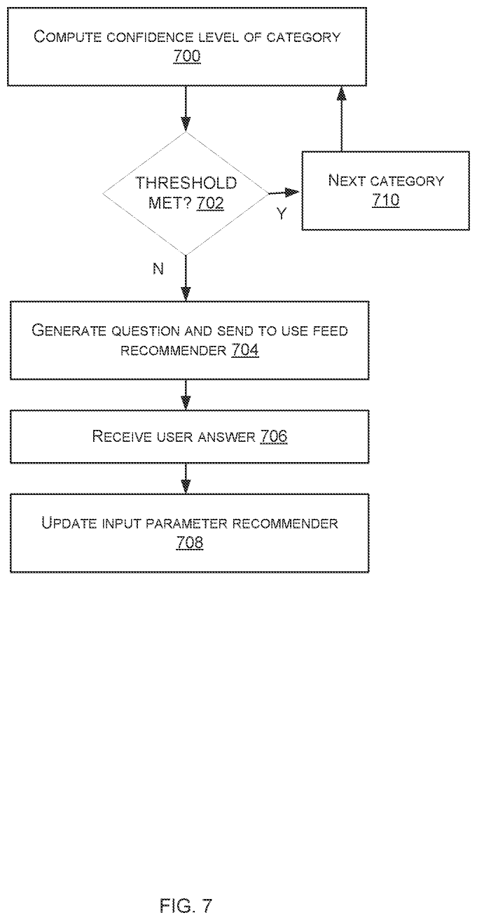

FIG. 7 is a flow diagram of a method performed by an information seeking engine 206. The information seeking engine 206 aims to actively engage with the user to seek new information by identifying what inputs from the user would provide the most information (in the technical sense). This takes the service further than approaches which passively analyse the user behaviour data. The information seeking engine 206 identifies a gap in the observed interactions and generates a question to present to the user to fill the gap. A gap in the observed interactions is an unobserved value in a range of possible values, or an unobserved category in a list of possible categories.

From a technical perspective, the information seeking engine 206 analyses the statistical confidence level associated with various categories of information to determine where more information could increase confidence (and therefore accuracy of generated visual content items). The information seeking engine 206 computes 700 a confidence level of a category from a list of possible categories. To compute the confidence level the information seeking engine 206 checks observed interactions there are for the category. If there are observed interactions the confidence is high. If the confidence level is above a threshold the information seeking engine moves to the next category 710. If the confidence is below the threshold (at decision point 702 of FIG. 7) the information seeking engine moves to operation 704.

At operation 704 the information seeking engine generates a question and sends the question to the user feed recommender. The generated question is about the category where confidence is low.

For example, the engine may identify that there is a high confidence level in terms of what colour(s) to use in a visual content item (because the user has indicated through text and/or behaviour that they like blue) but there is a low confidence level in terms of what lighting to use (should it be bright, sunny, dark, ambient, focused, etc). Based on this, the engine may generate a question to ask the user such as “what type of lighting do you want? [bright/sunny/dark/ambient/focused/other]”. If the user responds to this question, the machine will be able to more confidently select the lighting when generating visual content items, thereby creating better visual content items for the user.

Where an answer to the question is received 706 an update to the input parameter recommender is made 708.

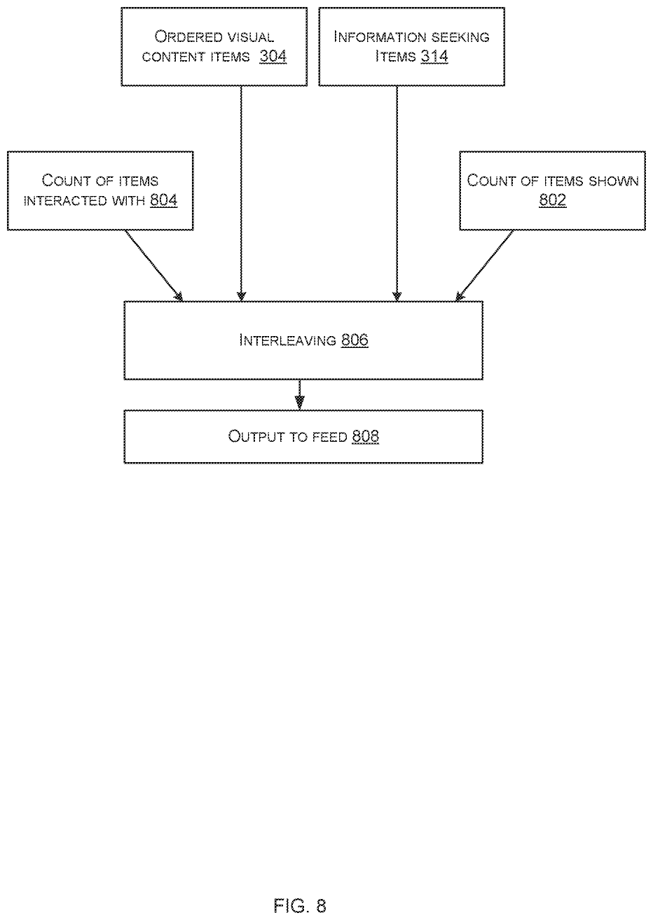

FIG. 8 is a flow diagram of a method performed by a user feed recommender 208. The user feed recommender 208 determines what to show the user in their feed. This is a mix of ordered visual content items 304 from the output recommender and information seeking items 314 from the information seeking engine. The user feed recommender 208 accesses a count of information seeking items interacted with 804 and a count of information seeking items shown 802. The user feed recommender 208 comprises a function that interleaves 806 visual content items and information seeking items 314 based on how many information seeking items 314 have been shown and how many the user has interacted with (e.g. if the service has shown a lot of information seeking items and the user isn't interacting with them, then it might not be worth showing them many more). Once the interleaving is done the visual content items and information seeking items are output to a feed 808.

Explicit iterative user feedback is defined by interactions where the user provides some text input to iterate on the visual content items they are seeing (e.g. “put a cat in the picture”). Use the intent-to-visual content item large language model to transcribe this feedback into a visual content item description.

Unlike other behavioural interactions in the user feed (such as liking or disliking a visual content item) which provide implicit feedback, which affects what the user sees by affecting the various recommenders' functions, this explicit user feedback directly modifies what is generated by adjusting the user input prompts (and other attributes, e.g. if the user says “make the lighting brighter”, it might both adjust the user input prompt and, through that process, affect what lighting choice the input parameter recommender makes).

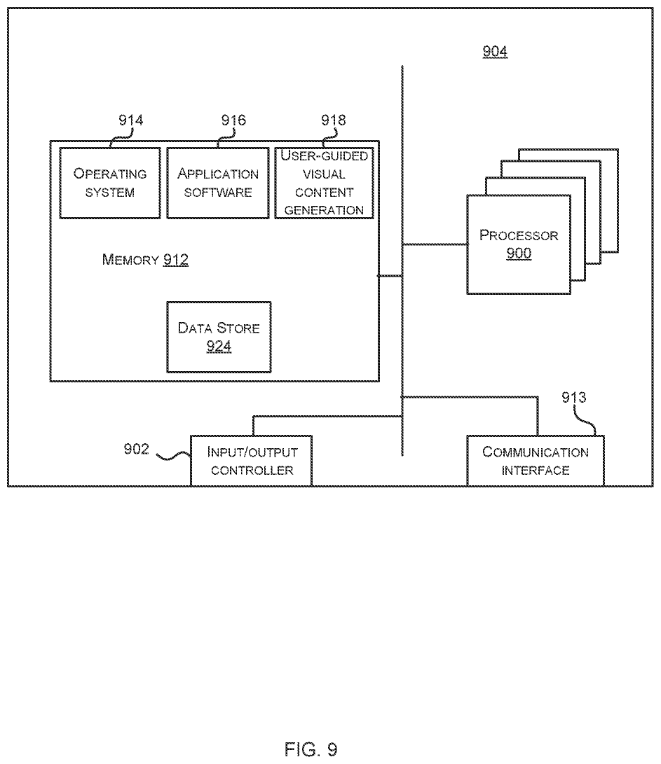

FIG. 9 is a schematic diagram of a computer used to implement a user-guided visual content generation service. FIG. 9 illustrates various components of an example computing device 904 in which embodiments of a user-guided visual content generation service are implemented in some examples. The computing device is of any suitable form such as a web server, compute node in a data centre or other computing device.

The computing device 904 comprises one or more processors 900 which are microprocessors, controllers or any other suitable type of processors for processing computer executable instructions to control the operation of the device in order to perform the methods of FIGS. 3 to 8. In some examples, for example where a system on a chip architecture is used, the processors 900 include one or more fixed function blocks (also referred to as accelerators) which implement a part of the method of FIGS. 3 to 8 in hardware (rather than software or firmware). That is, the methods described herein are implemented in any one or more of software, firmware, hardware. The computing device has a data store 924 holding visual content items, parameter values, prompts or other data. The computing device has a user-guided visual content generation service 918. Platform software comprising an operating system 914 or any other suitable platform software is provided at the computing-based device to enable application software 916 to be executed on the device. Although the computer storage media (memory 912) is shown within the computing-based device 904 it will be appreciated that the storage is, in some examples, distributed or located remotely and accessed via a network or other communication link (e.g. using communication interface 913).

The computing-based device 904 also comprises an input/output controller 902 arranged to output display information to a display device which may be separate from or integral to the computing-based device 904. The display information may provide a graphical user interface. The input/output controller 902 is also arranged to receive and process input from one or more devices, such as a user input device (e.g. a mouse, keyboard, camera, microphone or other sensor). In some examples the user input device detects voice input, user gestures or other user actions. In an embodiment the display device also acts as the user input device if it is a touch sensitive display device. The input/output controller 902 outputs data to devices other than the display device in some examples.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

Where the description has explicitly disclosed in isolation some individual features, any apparent combination of two or more such features is considered also to be disclosed, to the extent that such features or combinations are apparent and capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1. A method of generating a visual content item comprising:
receiving input from a user comprising text;
computing values of input parameters from the received input and from observed interactions with other visual content items by the user or other users;
generating the visual content item by inputting the computed values of the input parameters to a generative machine learning apparatus.

2. The method of claim 1 wherein the observed interactions are behavioural interactions, a behavioural interaction comprising a user interface event associated with a visual content item displayed at a user interface.

3. The method of claim 1 wherein the observed interactions are textual interactions, a textual interaction comprising text input by a user associated with a visual content item displayed at a user interface, or modifications to a prompt used to generate a visual content item displayed at a user interface.

4. The method of claim 1 wherein the input parameters comprise: models, prompts and inference parameters.

5. The method of claim 1 wherein the input parameters comprise at least one inference parameter selected from: initial latent noise, guidance scale, number of inference steps, resolution, noise schedule, negative prompt.

6. The method of claim 1 wherein computing values of the input parameters comprises selecting a model from a database of models according to at least one of four values:
a number of visual content items produced by each model which have been liked;
a priori probability for each model based on user preference;
a prior probability over the models across users;
a most likely model to be chosen according to a prompt.

7. The method of claim 6 comprising selecting a model from the database of models by, for each model, aggregating the four values and selecting one of the models by comparing the aggregated values with a threshold.

8. The method of claim 1 wherein at least one of the input parameters is a prompt and wherein computing values of input parameters comprises computing a value of the prompt by adding a suffix or prefix to text input by the user.

9. The method of claim 1 wherein at least one of the input parameters is a prompt and wherein computing values of input parameters comprises computing a value of the prompt by using a large language model to enhance a text prompt input by the user.

10. The method of claim 9 wherein the large language model has been fine-tuned using prompts liked by other users.

11. The method of claim 1 wherein at least one of the input parameters is a prompt and wherein computing values of input parameters comprises computing multiple variations of a user's input to vary any of: hair color of a person depicted in the generated visual content item, lighting depicted in the generated visual content item, viewpoint of the generated visual content item, style of the generated visual content item.

12. The method of claim 1 wherein at least one of the input parameters is a prompt and wherein computing values of input parameters comprises using a large language model to convert the target audience or the product description into a prompt that describes a visual content item.

13. The method of claim 1 wherein at least one of the input parameters is a prompt and wherein computing values of input parameters comprises using a large language model to incorporate textual feedback from a user into a prompt.

14. The method of claim 1 which is repeated and wherein an exploration coefficient is decayed as the method of claim 1 repeats, the exploration coefficient influencing how the values of the input parameters are computed so that when the exploration coefficient is high variation between visual content items generated by the method is high and when the exploration coefficient is low variation between visual content items generated by the method is low.

15. The method of claim 1 comprising ranking the generated visual content item according to similarity to visual content items liked by the user; and only displaying the generated visual content item in response to a rank of the generated visual content item being over a threshold.

16. The method of claim 1 comprising identifying a gap in the observed interactions and generating a question to present to the user to fill the gap.

17. The method of claim 16 comprising interleaving the generated visual content item and the generated question according to how many generated questions the user has previously answered.

18. The method of claim 1 comprising presenting the generated visual content item to a user, receiving text feedback from the user, using a large language model to enhance a prompt using the received text feedback or to compute values of the input parameters.

19. An apparatus for generating a visual content item comprising:
a processor;
a memory storing instructions which when executed on the processer implement operations comprising:
receiving input from a user comprising text;
computing values of input parameters from the received input and from observed interactions with other visual content items by the user or other users;
generating the visual content item by inputting the computed values of the input parameters to a generative machine learning apparatus.

20. An apparatus for generating an image comprising:
a processor;
a memory storing instructions which when executed on the processer implement operations comprising:
receiving input from a user;
computing values of input parameters from the received input and from observed interactions with other images by the user or other users, where an observed interaction is a user interface event associated with an image displayed at a user interface;
generating the image by inputting the computed values of the input parameters to a generative machine learning apparatus.
